(19) United States
(12) Patent Application Publication
(10) Pub. No.: US 2005/0207868 A1
(43) Pub. Date: Sep. 22, 2005

(54) Bolt set made of steel

(76) Inventors: Nobuyoshi Uno, Futtsu-shi (JP); Mamoru Suzuki, Osaka-shi (JP); Toshio Miyagawa, Yukuhashi-shi (JP); Kouzou Wakiyama, Ibaraki-shi (JP); Keiji Hirai, Fukuoka (JP)

Correspondence Address: LAW OFFICES OF JACOBSON HOLMAN;PROFESSIONAL LIMITED LIABILITY COMPANY, 400 SEVENTH STREET, N. W., WASHINGTON, DC, 20004, US

(21) Appl. No.: 11/085,596

(22) Filed: Mar. 22, 2005

(30) Foreign Application Priority Data
Mar. 22, 2004 (JP) 2004-082640

(51) Int. Cl. F16B 25/00

(52) U.S. Cl. 411/386; 411/366.1

(57) ABSTRACT

A bolt set is provided that is made of steel free from technical difficulties in production, inexpensive in production cost, and improved in fatigue strength by a simple configuration. More particularly, a bolt set made of steel in which a tensile fluctuation stress acts upon an external thread side, characterized by setting a pitch difference ΔP(=Pf−Pm) between a pitch Pm of the external thread and a pitch Pf of the internal thread within a range of 0.5-0.8% based on a pitch P prescribed in JIS B 0205 of Japan Industrial Standard.

### BACKGROUND OF THE INVENTION

1. Field of the Invention

The present invention relates to a bolt set made of steel used for fastening structural bodies, members, and parts in civil engineering structures, building structures, and machinery (machine tools, automobiles, rolling stock, rolling mills, etc.) upon which repeated force (load) acts.

2. Description of the Related Art

In a screw joint, even when the external thread and the internal thread geometrically correctly fit with each other, the problem arises that the load distribution of the tensile stress acting upon the screw thread is largely biased to the tensile stress side and causes plastic deformation from the crests on the tensile stress load side and breaks the crests.

In order to solve this problem, as a screw joint improved in fatigue characteristic, Japanese Patent Publication No. 52-79163, and Japanese Patent Publication No. 52-131060, which represents Conventional Examples 1 and 2, respectively, disclose to shape an external thread to be engaged with an internal thread to become thinner toward the tip at the bolt head side in the direction of tensile force so as to reduce a contact area between the external thread and the internal thread toward the tensile direction and equalize the load applied on the crests and thereby achieve an improvement of the fatigue life. Japanese Patent Publication No. 53-29780, which represents Conventional Example 3, discloses to improve the shapes of the crests so as to relieve the stress concentration at the roots and thereby achieve an improvement of the fatigue life. Japanese Patent Publication No. 58-160613, which represents Conventional Example 4, discloses to make one or both of the crest flank angles of the internal thread to be engaged with the external thread smaller than the flank angle of the external thread to equalize the load borne by the crests and thereby achieve an improvement of the fatigue characteristic. Japanese Patent Publication No. 2003-4016, which represents Conventional Example 5, discloses a set of a high strength bolt, nut, and washer reduced in stress concentration occurring at the engaged end roots and improved in delayed breakage resistance characteristic and fatigue resistance characteristic by forming the shapes of the roots by a high order curve.

Further, Report on Survey and Research for Standardization Concerning Fastening Performance of High Strength Bolts (First Report), Japan Research Institute for Screw Threads and Fasteners, 1978, which represents Conventional Example 6, discloses that the fatigue strength can be improved if the pitch of the external thread is made smaller than the pitch of the internal thread and the pitch difference thereof is about 0.3%.

However, forming an external thread to be engaged with an internal thread to become thinner toward the tip in the direction of tensile force on the bolt head side as in Conventional Examples 1 and 2 has the problem that the production cost is high and the problem that the optimum engagement position of the nut is fixed, so there is almost no leeway left for a change of the fastening length. Further, improving the thread shape so as to relieve stress concentration of the roots as in Conventional Example 3 has the problem that the flank angle differs between a metric thread and unify thread, so the production cost becomes high. Making one or both of the thread flank angles of an internal thread to be engaged with an external thread smaller than the flank angle of the external thread to equalize the load borne by the crests as in Conventional Example 4 has the problem that sophisticated production technology is necessary and production control and quality control take enormous time, so the production cost swells. Forming the shape of the roots by a high order curve so as to reduce stress concentration occurring at the engaged end roots as in Conventional Example 5 has the problem that sophisticated production technology is necessary and production control and quality control take enormous time, so the production cost swells.

Further, making the pitch of the external thread smaller than the pitch of the internal thread and making the pitch difference thereof about 0.3% as in Conventional Example 6 has the problem that while there is an effect of improvement, but this extent of pitch difference is frequently absorbed by the tolerance between the external thread and the internal thread in an actual bolt set, so the obtained effect of improvement of fatigue strength is remarkably small in practical use.

### SUMMARY OF THE INVENTION

The present invention has as its object to provide a bolt set made of steel solving the above problems of the prior art, free from technical difficulties in production, inexpensive in production cost, and improved in fatigue strength by a simple configuration.

According to a first aspect of the present invention, there is provided a bolt set made of steel wherein a tensile fluctuation stress acts upon an external thread side, characterized in that a pitch difference ΔP(=Pf−Pm) between a pitch Pm of an external thread and a pitch Pf of an internal thread is set within a range of 0.5-0.8% of a pitch P prescribed in JIS B 0205 of the Japan Industrial Standard (hereinafter referred to as the “JIS pitch P”).

A second aspect of the present invention provides a bolt set made of steel as set forth in the first aspect of the present invention, wherein either of the pitch Pm of said external thread or the pitch Pf of said internal thread coincides with the JIS pitch P.

A third aspect of the present invention provides a bolt set made of steel as set forth in the first or second aspect of the present invention, wherein the strength of said bolt set is higher than a strength class 12.9 prescribed in JIS B 1051.

A fourth aspect of the present invention provides a bolt set made of steel as set forth in any one of the first to third aspects of the present invention, wherein the external thread of said bolt set is shaped by rolling after heat treatment of the bolt.

According to the present invention, by the constitution of making the pitch difference ΔP(=Pf−Pm) between the pitch Pm of the external thread and the pitch Pf of the internal thread a range of 0.5-0.8% of the pitch P prescribed in JIS B0205 (hereinafter referred to as the “JIS pitch”), the load borne by the external thread when tensile force acts upon the bolt set made of steel is schematically equalized, whereby the occurrence of local stress concentration is prevented and the fatigue strength is much improved. This is also effective for improvement of the delayed breakage characteristic. Further, an adjustment of the fastening length is possible. If the pitch difference ΔP is larger than 0.8%, the engagement of the external thread and the internal thread becomes difficult, while if the pitch difference ΔP is smaller than 0.5%, a sufficient effect cannot be exhibited.

By the constitution of setting the pitch of either of the external thread or internal thread to the JIS pitch and changing the pitch of the other thread with respect to the JIS pitch by the pitch difference ΔP, the JIS pitch can be used, so the production cost can be reduced.

Production is possible just by changing the die, so production is not technically difficult and the production cost can be made inexpensive.

The invention can be applied to any type of thread, so the range of application is wide.

It is possible to apply the invention to both of anchor bolt sets and high strength bolt sets.

By rolling the bolt thread after the heat treatment, compression residual stress is imparted to the roots and the fatigue strength is improved.

### BRIEF DESCRIPTION OF THE DRAWINGS

FIGS. 1(a), 1(b), 1(c), and 1(d) are diagrams showing changes when tensile force acts upon a bolt set made of steel of the present invention.

FIG. 2 is a diagram showing evaluation points of the degree of stress of a root of an external thread.

FIG. 3 is a diagram showing the states of load borne by screw threads of an external thread when different tensile forces act in the case where the pitch of the external thread and the pitch of the internal thread are equal.

FIG. 4 is a diagram showing the states of load borne by screw threads of an external thread when different tensile forces act upon a bolt set of the present invention where the pitch difference is 0.5%.

FIG. 5 is a diagram showing the degrees of stress of the roots of screw threads of an external thread when tensile force acts in the case where the pitch of the external thread and the pitch of the internal thread are equal.

FIG. 6 is a diagram showing the degrees of stress of the roots of screw threads of an external thread when tensile force acts upon a bolt set of the present invention where the pitch difference is 0.3%.

FIG. 7 is a diagram showing the degrees of stress of the roots of screw threads of an external thread when tensile force acts upon a bolt set of the present invention where the pitch difference is 0.5%.

FIG. 8 is a diagram showing the degrees of stress of the roots of screw threads of an external thread when tensile force acts upon a bolt set of the present invention where the pitch difference is 0.8%.

FIG. 9 is a diagram showing curves of the degrees of stress of the root of a first screw thread with respect to a mean stress degree of the screw threads for different pitch differences.

### DETAILED DESCRIPTION OF THE PREFERRED EMBODIMENTS

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

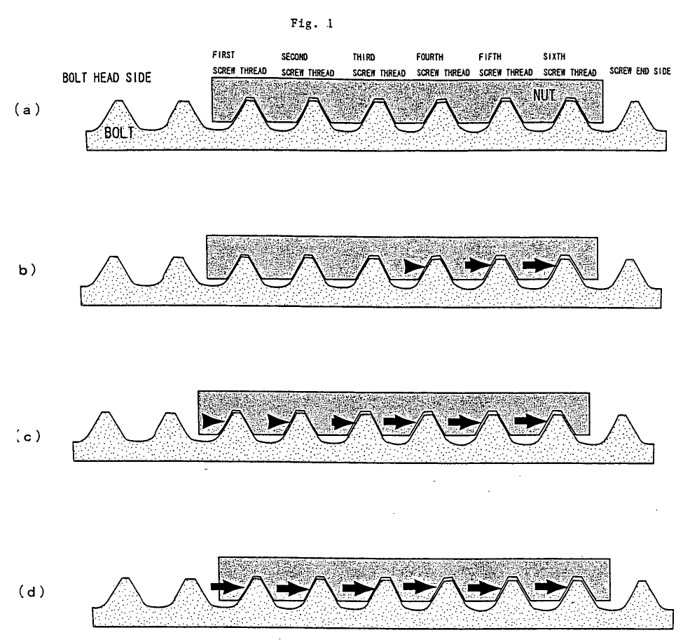

An embodiment of the present invention will be explained according to the drawings. FIGS. 1(a), 1(b), 1(c), and 1(d) show states of distribution of the load acting upon the crests when tensile force acts upon a bolt set made of steel of the present invention where the pitch Pm of the external thread is made smaller than the pitch Pf of the internal thread.

Step 1: FIG. 1(a) shows a state when setting the bolt and nut (bolt tension=0). Assume there are first to sixth screw threads in sequence from the bolt head side to the thread end side. In this state, the thread flank surfaces of the bolt and the nut of the sixth screw thread contact each other at the bolt head side, the thread surfaces of the bolt and nut of the first screw thread to the fifth screw thread do not contact each other at the bolt head side, and the clearance on the bolt head side becomes larger from the fifth screw thread toward the first screw thread. Conversely, the thread flank surfaces of the bolt and nut of the first screw thread to the fifth screw thread contact each other on the thread end side, so the contact pressure increases from the fifth screw thread toward the first screw thread.

Note that the figure is drawn so that part of the crests of the external thread and part of the crests of the internal thread are superimposed on each other in order to visually express the magnitude of the contact pressure. The larger this superimposition, the larger the contact pressure shown. In actuality, however, the crests of the external thread and the crests of the internal thread are not superimposed on each other as in the figure. The same is true also for the following steps 2 to 4.

Step 2: FIG. 1(b) shows a state where tensile force acts upon the bolt set in a direction indicated by the arrows and the bolt tension gradually increases. Along with the increase of the bolt tension, the screw threads of the external thread sequentially start bearing load from the sixth screw thread toward the first screw thread. At this time, the load borne is the maximum at the sixth screw thread and becomes smaller toward the bolt head side. In the initial stage of action of the tensile force, the thread flank surfaces on the bolt head side of the bolt and nut of the first screw thread and the second screw thread do not yet contact each other.

Step 3: FIG. 1(c) shows a state where the tensile force acting upon the bolt set further increases. All screw threads of the first screw thread to the sixth screw thread bear load. The load borne is the maximum in the sixth screw thread and becomes smaller toward the first screw thread.

Step 4: FIG. 1(d) shows a state where the tensile force acting upon the bolt set further increases. The roots of the threads start yielding from the sixth screw thread toward the first screw thread. The stress is redistributed along with the increase of the plastic strain of the roots, so the load borne by the screw threads of the external thread becomes uniform.

The state of the load borne by the screw threads of a bolt in the case of a general bolt set with no pitch difference and the case of a bolt set of the present invention having a pitch difference are shown below for bolt sets made of steel having a nominal size of M22. As the bolt material, a steel material having a yield point of 1300 N/mm² and a plastic hardening rate of 0.5% was used. As the nut material, a steel material having a yield point of 900 N/mm² and a plastic hardening rate of 0.5% was used. Further, for the shape of the external thread, the invention disclosed in Japanese Patent Publication (B) No. 6-89768 (high strength bolt, nut, and washer set) was employed.

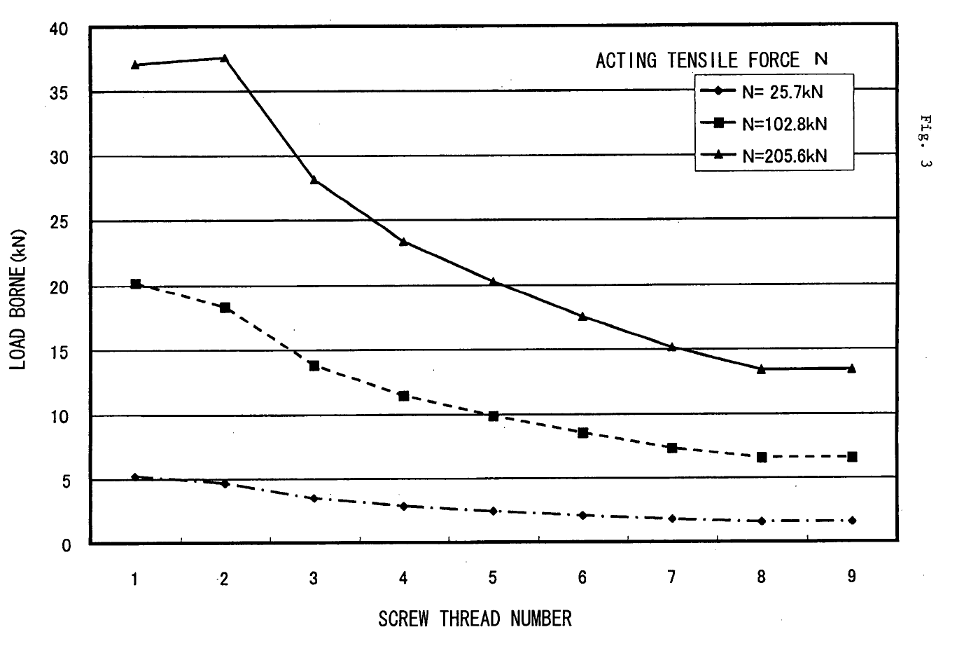

FIG. 3 shows states of the loads borne by the screw threads of external threads when different tensile forces act upon a general bolt set where the pitch Pm of the external thread and the pitch Pf of the internal thread are equal, that is, there is no pitch difference. The notations N in the legend in the figure show the acting tensile force. In this case, the load borne when the tensile force acts is the maximum at the first screw thread and becomes smaller from the first screw thread toward the ninth screw thread. Note that the first screw thread through the ninth screw thread are shown from the bolt head side toward the thread end side.

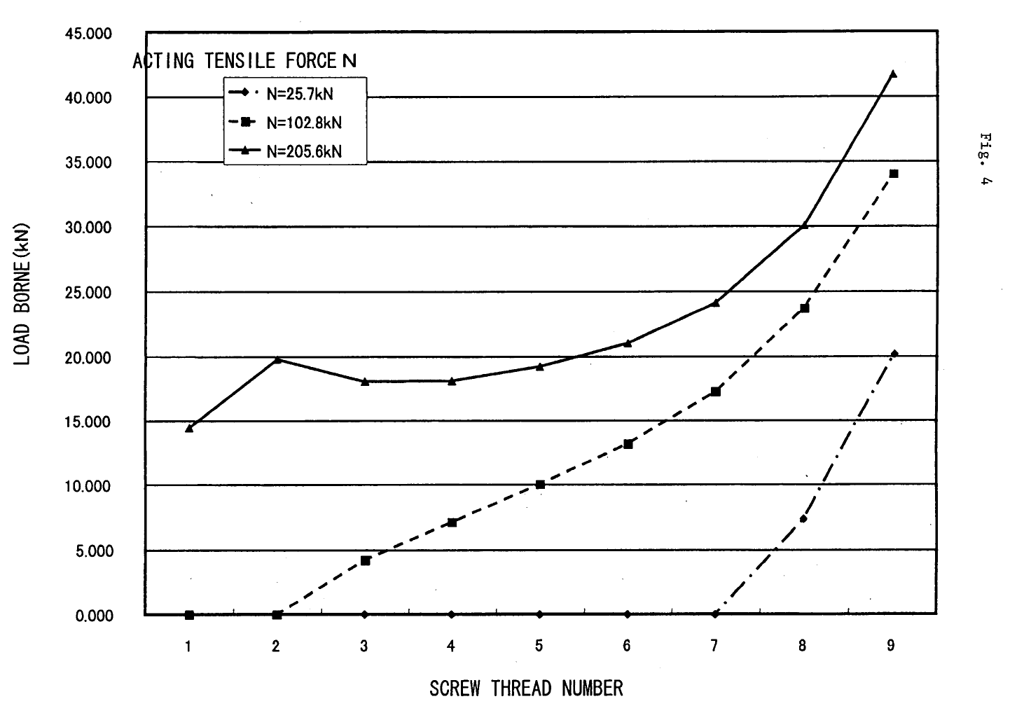

FIG. 4 shows states of the loads borne by the screw threads of external threads when different tensile forces act upon a bolt set of the present invention where the pitch difference ΔP is 0.5%. In this case, the load borne when the tensile force acts is the maximum at the ninth screw thread and becomes smaller from the ninth screw thread toward the first screw thread.

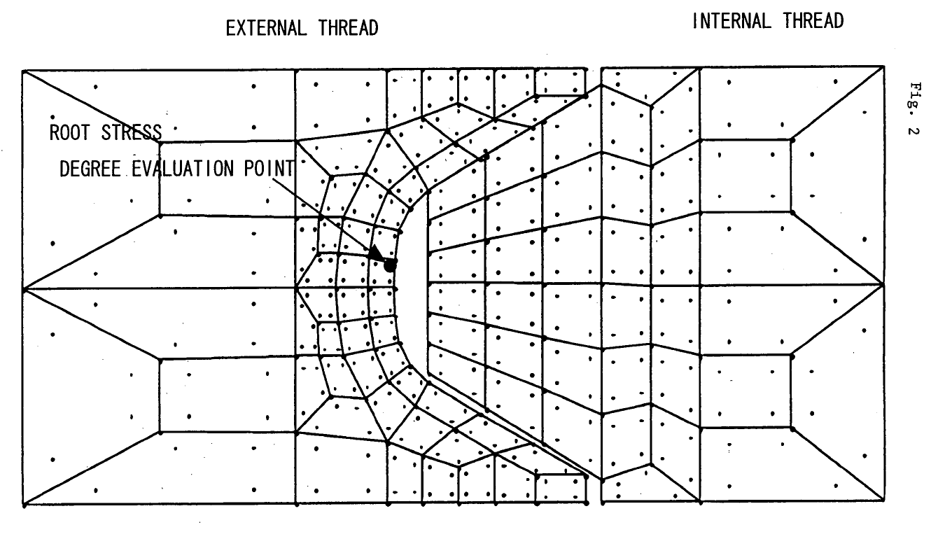

Next, the states of stress of roots of screw threads of bolts in the case of a general bolt set with no pitch difference and the case of a bolt set of the present invention having a pitch difference are shown for bolt sets made of steel having a nominal size of M22. FIG. 2 shows evaluation points of the degree of stress of the roots of the bolt screw threads.

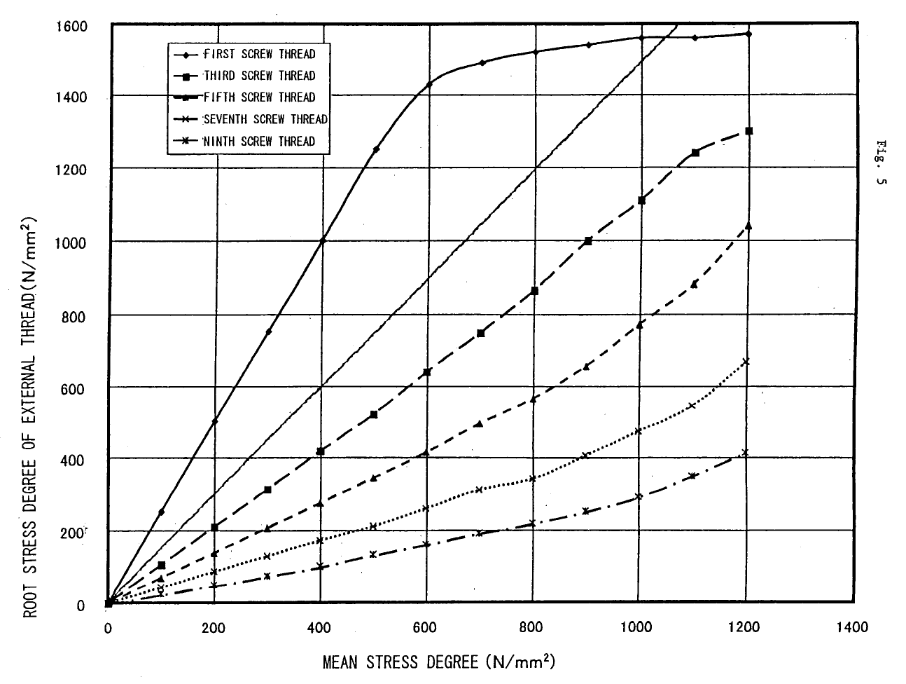

FIG. 5 shows the states of the degrees of stress of the roots of the different screw threads of an external thread (hereinafter, referred to as the “root stress degree”) when tensile force acts upon a general bolt set wherein the pitch Pm of the external thread and the pitch Pf of the internal thread are equal, that is, there is no pitch difference. The ordinate indicates the degrees of stress of the roots of the screw threads, and the abscissa indicates the mean stress degrees of the effective cross-sections of the screw threads (hereinafter, referred to as the “screw thread mean stress degree”). The stress concentration coefficient of the roots of the external thread employed here is about 1.5. Accordingly, if the load borne by the screw threads of the external thread becomes uniform, as shown in FIG. 5, the relationship between the screw thread mean stress degree and the root stress degrees of the screw threads substantially coincides with the standard curve indicated by a straight line obtained by multiplying the screw thread mean stress degree by the coefficient 1.5. In the diagram shown in FIG. 5, the curves indicating the states of the degrees of stress of the roots of the screw threads with respect to the screw thread mean stress degrees are far away from the standard curve. The root stress degree of the first screw thread when tensile force acts is the maximum. The degree becomes smaller from the root of the first screw thread toward the root of the ninth screw thread.

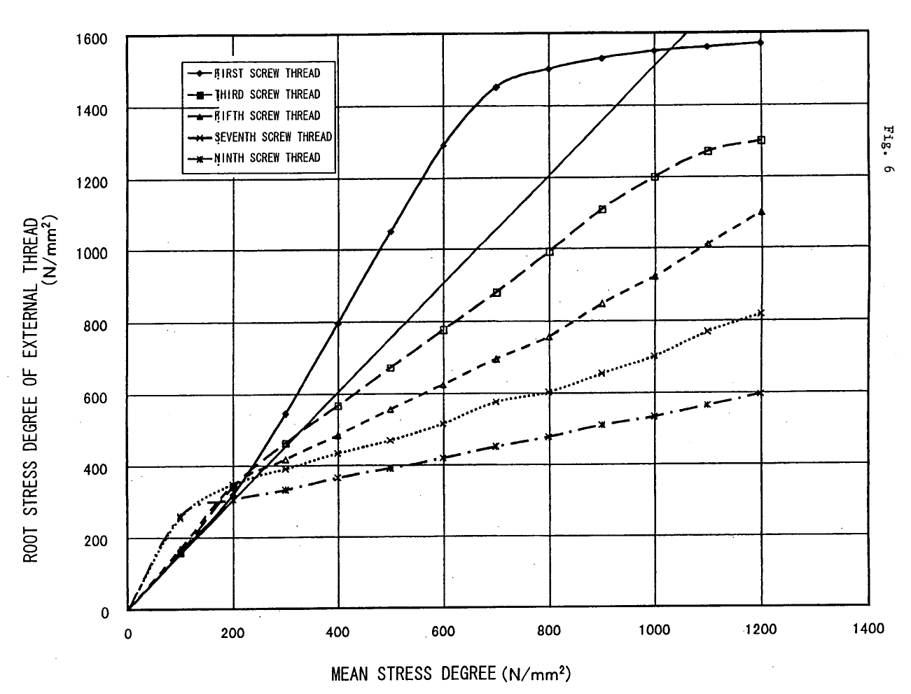

FIG. 6 shows the changes of the root stress degrees of the screw threads of the external thread when tensile force acts upon a bolt set of the present invention where the pitch difference ΔP is 0.3%. In comparison with FIG. 5 where there is no pitch difference between the external thread and the internal thread, the curves of the degrees of stress of the roots of the screw threads with respect to the screw thread mean stress degrees become closer to the standard curve. In particular, up to the time when the screw thread mean stress degree is 200 N/mm², the curves of the root stress degrees of the screw threads substantially overlap the standard curve. This shows that the load borne by the screw threads has become uniform. Note that, in the present analysis, the computation is made by setting the tolerance to 0. In actuality, there is tolerance, so the effect of improvement of the fatigue strength is small with this extent of pitch difference.

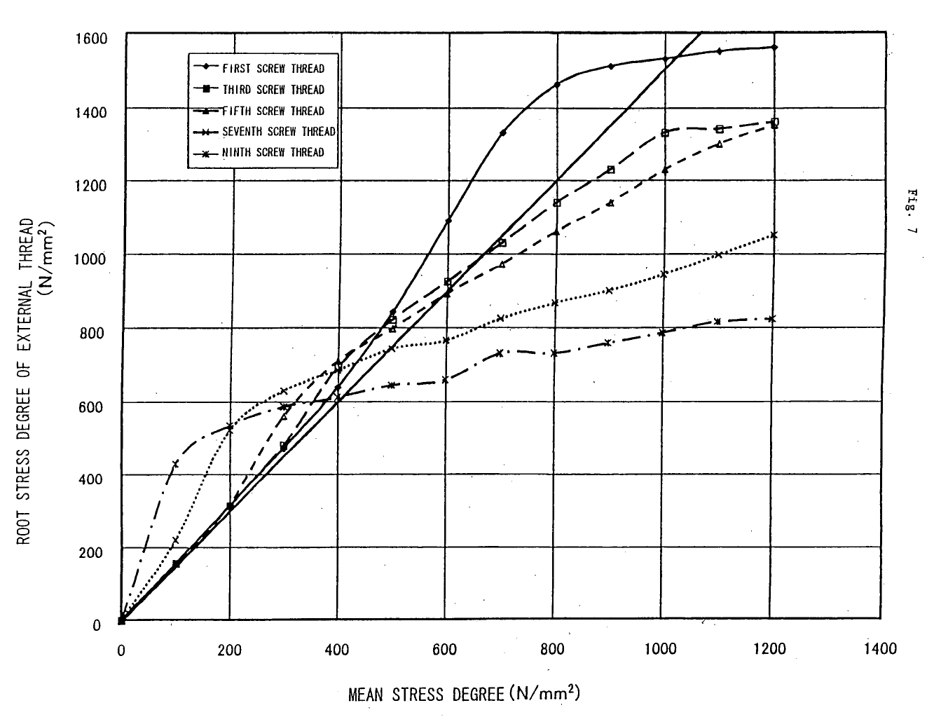

FIG. 7 shows the changes of the root stress degrees of the screw threads of the external thread when tensile force acts upon a bolt set of the present invention where the pitch difference ΔP is 0.5%. In comparison with the case of FIG. 6, the curves of the degrees of stress of the roots of the screw threads with respect to the screw thread mean stress degrees become further closer to the standard curve even when the screw thread mean stress degree is large (400 N/mm²). The load borne by the screw threads becomes uniform over the entire area of the screw thread mean stress degree and, at the same time, the root stress degree of the first screw thread particularly effective for improving the fatigue strength is far reduced in comparison with the case where there is no pitch difference and the case where ΔP=0.3%.

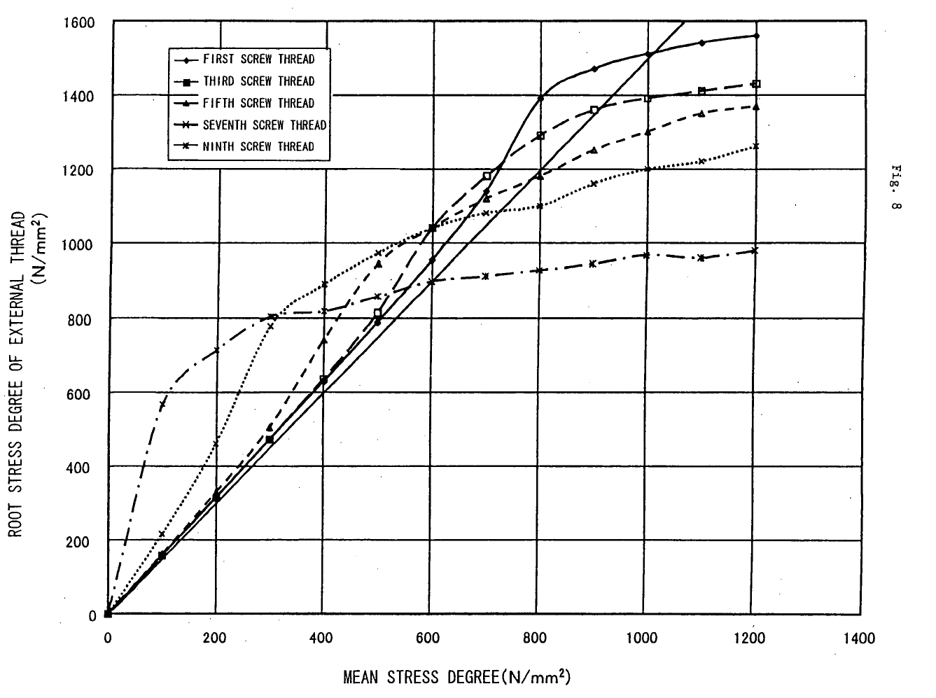

FIG. 8 shows the changes of the stress degrees of the roots of screw threads of the external thread when tensile force acts upon a bolt set of the present invention where the pitch difference ΔP is made further larger, that is, where the pitch difference ΔP is 0.8%. In comparison with the case of FIG. 7, the curves of the degrees of stress of the roots of the screw threads with respect to the screw thread mean stress degrees become further closer to the standard curve even when the screw thread mean stress degree is further larger (600 N/mm²), and the load borne by the screw threads becomes more uniform over the entire area of the screw thread mean stress degree. Further, the root stress degree of the first screw thread is further reduced, and improvement of the fatigue strength over a wide range of the screw thread mean stress degree is possible.

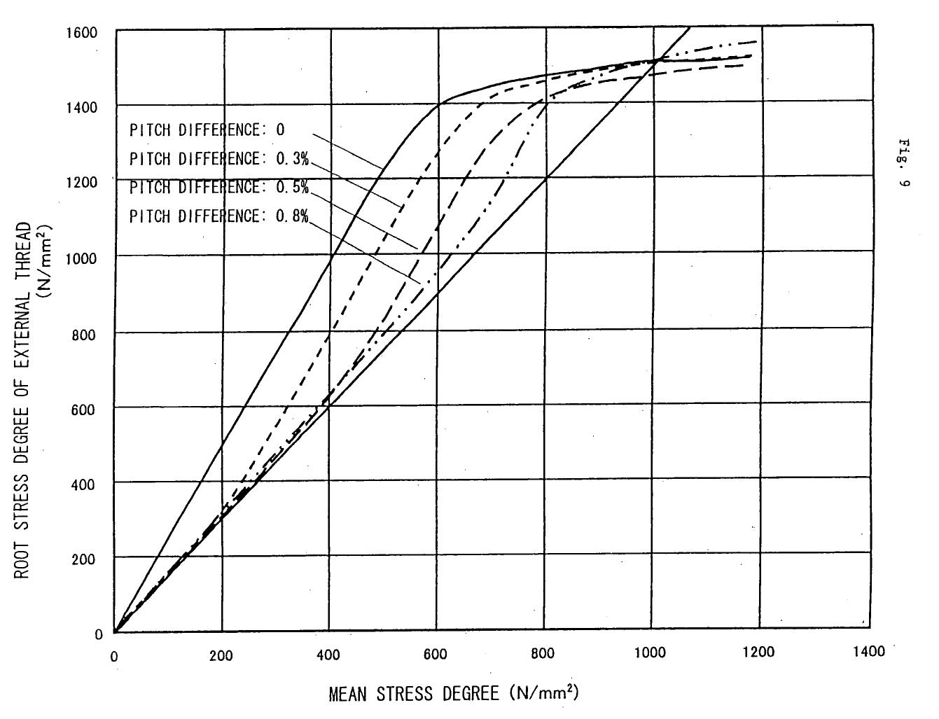

FIG. 9 shows curves of the degrees of stress of the root of the first screw thread with respect to the screw thread mean stress degrees for different pitch differences ΔP. The larger the pitch difference ΔP, the nearer the root stress degree of the first screw thread to the standard curve. It is learned that the effect of improvement of the fatigue strength is large in a wide range of the screw thread mean stress degree.

Table 1 shows results of fatigue tests on bolt sets made of steel of the present invention and conventional bolt sets. The fatigue tests were executed by using servo jack test machines of 500 KN and 1000 KN, wherein the repetition load was a sine wave and the load rate was 300 times/min. In the table, the “JIS” in the column of the screw shape shows the metric thread. In the conventional bolt sets, both of the pitches of the external threads and internal threads are the JIS pitch. In the bolt sets of the present invention, the pitch difference ΔP is changed to three levels with respect to the two levels of the case where the pitch of the internal thread is fixed to the JIS pitch and the case where the pitch of the external thread is fixed to the JIS pitch P. Further, the pre-rolling was carried out by rolling the external thread before the heat treatment, and the post-rolling was carried out by rolling the external thread after heat treatment. The stress ratio is the ratio between the minimum stress degree and the maximum stress degree. The test results are values of all amplitudes. The test pieces in the shaded portions in the table show breakage in the lower portions of the bolt necks. The other pieces broke at the first screw thread of the nut.

TABLE 1
Fatigue Test Results of Bolt of Present Invention and Conventional Bolts

(Unit: N/mm²)

| | | | | | | | Present invention | | | | | | | |
|---|---|---|---|---|---|---|---|---|---|---|---|---|---|---|
| | | | Related art | | | | Change of pitch of external | | | | Change of pitch of internal | | | |
| | | | | JP52-79163 | | | thread (ΔP) | | | | thread (ΔP) | | | |
| | | | | Bolt | | | 0.3% | 0.5% | 0.8% | | 0.3% | 0.5% | 0.8% | |
| Test | Bolt | Thread | Basic | Pre | Post | | Pre | | | Post | Pre | | | Post |
| load | strength | shape | set | rolling | rolling | Nut | rolling | | | rolling | rolling | | | rolling |
| Constant | 10T | JIS | 71 | 93 | 140 | 86 | 81 | 105 | 107 | 141 | 78 | 102 | 105 | 140 |
| stress | 14T | SHTB | 127 | 140 | 172 | 136 | 130 | 172 | 170 | 170 | 129 | 171 | 175 | 175 |
| ratio 5/8 | | | | | | | | | | | | | | |
| Constant | 10T | JIS | 84 | 111 | 123 | 103 | 95 | 116 | 114 | 122 | 93 | 113 | 114 | 122 |
| mean | 14T | SHTB | 108 | 131 | 147 | 117 | 115 | 148 | 150 | 150 | 113 | 146 | 149 | 145 |
| stress | | | | | | | | | | | | | | |
| 0.7 × tensile | | | | | | | | | | | | | | |
| strength | | | | | | | | | | | | | | |

In connection with Table 1, the following notes are pertinent: 1) the fatigue test method is executed by using servo jack test machines of 500 KN and 1000 KN; the repetition load was a sine wave, and the loading rate was 300×/min. 2) The basic set has both bolt and nut with JIS pitch P as pitch. 3) Pre rolling is rolling the external thread before heat treatment, and post rolling is rolling the external thread after heat treatment. 4) In the case of change of the external thread pitch, the internal thread pitch is made JIS pitch P. 5) In the case of change of the internal thread pitch, the external thread pitch is made JIS pitch P. 6) Stress ratio=minimum stress degree/maximum stress degree. 7) Test results are values of all amplitudes. 8) Test pieces in the shaded portions broke at the lower portion of the bolt neck, while the other pieces broke at the first screw thread in the nut.

It is learned from the fatigue test results shown in Table 1 that the bolt sets made of steel of the present invention exhibit effects of improvement of fatigue strength equivalent to that of the invention disclosed in Patent Document 1 and that the fatigue strength is much improved in comparison with the conventional bolt sets with no special threading. Note that, in the bolt sets made of steel of the present invention, since the improvements of the fatigue strength at the external threads were so great, in the fatigue tests, the fatigue strengths of the bolt sets made of steel were determined by the fatigue strengths of the lower portions of the bolt necks. Accordingly, if combining the shape of the lower portion of the neck of a bolt set made of steel of the present invention with for example a shape enabling stress concentration to be relieved as in the invention disclosed in Japanese Patent Publication (B) No. 6-89768, the fatigue strength is further improved.

The bolt set made of steel of the present invention can be applied to not only general metric thread, but also metric trapezoidal thread or pipe use parallel thread.

Further, the bolt set made of steel of the present invention can be applied to anchor bolts and stud bolts.

The invention being thus described, it will be apparent that the same may be varied in many ways. Such variations are not to be regarded as a departure from the spirit and scope of the invention, and all such modifications as would be recognized by one skilled in the art are intended to be included within the scope of the following claims.

1. In a bolt set made of steel wherein a tensile fluctuation stress acts upon an external thread side, a bolt set made of steel excellent in fatigue strength characterized in that a pitch difference ΔP (=Pf−Pm) between a pitch Pm of an external thread and a pitch Pf of an internal thread is set within a range of 0.5-0.8% of a pitch P prescribed in JIS B 0205 of the Japan Industrial Standard (JIS pitch P).

2. A bolt set made of steel as set forth in claim 1, wherein either of the pitch Pm of said external thread or the pitch Pf of said internal thread coincides with the JIS pitch P.

3. A bolt set made of steel as set forth in claim 1, wherein the strength of said bolt set is higher than a strength class 12.9 prescribed in JIS B 1051.

4. A bolt set made of steel as set forth in claim 1, wherein the external thread of said bolt set is shaped by rolling after heat treatment of the bolt.

5. A bolt set made of steel as set forth in claim 2, wherein either of the pitch Pm of said external thread or the pitch Pf of said internal thread coincides with the JIS pitch P.

6. A bolt set made of steel as set forth in claim 2, wherein the strength of said bolt set is higher than a strength class 12.9 prescribed in JIS B 1051.

7. A bolt set made of steel as set forth in claim 2, wherein the external thread of said bolt set is shaped by rolling after heat treatment of the bolt.

8. A bolt set made of steel as set forth in claim 3, wherein the external thread of said bolt set is shaped by rolling after heat treatment of the bolt.
